(19) United States
(12) Patent Application Publication
(10) Pub. No.: US 2025/0018436 A1
(43) Pub. Date: Jan. 16, 2025

(54) CLEANING DEVICE AND METHOD FOR EXTERNAL SENSOR

(71) Applicant: Honda Motor Co., Ltd., Tokyo (JP)

(72) Inventors: Ryota OKUTSU, Tokyo (JP); Motoki CHIBA, Tokyo (JP)

(73) Assignee: Honda Motor Co., Ltd., Tokyo (JP)

(21) Appl. No.: 18/677,925

(22) Filed: May 30, 2024

(30) Foreign Application Priority Data
Jul. 12, 2023 (CN) 202310853670.7

(51) Int. Cl. B08B 3/02; B60S 1/56

(52) U.S. Cl. CPC B08B 3/02; B60S 1/56

(57) ABSTRACT

The disclosure provides a cleaning device and a method for an external sensor. The external sensor is disposed on a moving body and configured to detect an outside of the moving body. The cleaning device includes: a cleaning part that sprays cleaning fluid on a detection surface of the external sensor for cleaning; and a sensor performance calculation part that calculates a performance detection value of the external sensor. The cleaning part sprays the cleaning fluid based on the calculated performance detection value. The cleaning part sprays the cleaning fluid based on a calculated change amount of the performance detection value with respect to time or a travel distance of the moving body.

### CROSS-REFERENCE TO RELATED APPLICATION

This application claims the priority benefit of China application serial no. 202310853670.7, filed on Jul. 12, 2023. The entirety of the above-mentioned patent application is hereby incorporated by reference herein and made a part of this specification.

### BACKGROUND

### Technical Field

The disclosure relates to a cleaning device and a method for an external sensor.

### Description of Related Art

In recent years, efforts to provide access to sustainable transportation systems that also take into account those in disadvantaged positions among transportation participants, such as the elderly, the disabled, and children, have been active. In order to achieve the above-mentioned purpose, research and development efforts are made to further improve the safety or convenience of transportation through developments related to the vehicle habitability.

Nowadays, many external sensors are equipped on the outside of vehicles to detect the external environment of the vehicle. Due to the influence of wind, rain, raised dust and sludge on the external sensors, the external sensors are susceptible to dirt.

Patent Document 1 (Japanese Patent Application Laid Open No. 2009-243963) discloses a technology that displays a message such as “The radome is dirty” on a display when it is determined that a detection performance of a millimeter-wave radar or the like has deteriorated. Furthermore, Patent Document 2 (Japanese Patent Application Laid Open No. 2001-199260) discloses a technology that, if it is detected that the camera is dirty, notifies the driver that dirt has been detected, sprays water on the windshield, and uses wipers to wipe away the dirt on the windshield. Furthermore, Patent Document 3 (Patent Document 3: Japanese Patent Application Laid Open No. 2023-28892) discloses a cleaning control device for a lidar window. The disclosure selectively switches between a continuous cleaning mode and an intermittent cleaning mode in which fluid is intermittently ejected.

When the vehicle is driven with sand or similar material being kicked up, the sensor may continue to become dirty. At this time, if the decontamination process is continued by continuously spraying cleaning fluid, a large amount of cleaning fluid will be consumed, and a problem that the cleaning fluid needs to be replenished more frequently will arise.

However, in terms of vehicle habitability, how to avoid excessive consumption of cleaning fluid for external sensors and optimize replenishment frequency thereof is an issue.

### SUMMARY

In order to solve the above problems, the disclosure aims to avoid excessive consumption of cleaning fluid for external sensors and optimize replenishment frequency thereof, so as to contribute to the development of sustainable transportation systems.

According to an embodiment of the disclosure, a cleaning device for an external sensor is provided. The external sensor is disposed on a moving body and configured to detect the outside of the moving body. The cleaning device for the external sensor includes: a cleaning part that sprays cleaning fluid on a detection surface of the external sensor for cleaning; and a sensor performance calculation part that calculates a performance detection value of the external sensor. The cleaning part sprays the cleaning fluid based on the calculated performance detection value. The cleaning part sprays the cleaning fluid based on a calculated change amount of the performance detection value with respect to time or a travel distance of the moving body.

According to another embodiment of the disclosure, a cleaning method for an external sensor is provided. The external sensor is disposed on a moving body and configured to detect the outside of the moving body. The cleaning method of the external sensor includes the following steps. Cleaning fluid is sprayed on a detection surface of the external sensor for cleaning. A performance detection value of the external sensor is calculated. The cleaning fluid is sprayed based on the calculated performance detection value. The cleaning fluid is sprayed based on a calculated change amount of the performance detection value with respect to time or a travel distance of the moving body.

According to the above-mentioned embodiments, in the case where the sensor continues to become dirty, unintentional consumption of the cleaning fluid is avoided by suppressing an execution of dirt removal. Thus, the replenishment frequency of the cleaning fluid can be optimized.

### BRIEF DESCRIPTION OF THE DRAWINGS

FIG. 1 is a schematic block diagram of a cleaning device for an external sensor according to an embodiment of the disclosure.

FIG. 2 is a schematic flowchart of a cleaning method for an external sensor according to an embodiment of the disclosure.

FIG. 3 is a diagram of an example of a performance detection according to an embodiment of the disclosure.

FIG. 4A is a schematic diagram of a short dirty cycle and repeated spraying of cleaning fluid.

FIG. 4B is a schematic diagram of a method of calculating an upward trend value of a degree of performance degradation.

FIG. 5A is a schematic diagram of another example of a short dirty cycle and repeated

spraying of cleaning fluid.

FIG. 5B is another method of calculating an upward trend value of a degree of performance degradation.

FIG. 6 is another method of calculating an upward trend value of a degree of performance degradation.

FIG. 7 is a schematic flowchart of a process of clearing a high frequency decontamination flag in an external sensor cleaning process according to an embodiment of the disclosure.

### DESCRIPTION OF THE EMBODIMENTS

According to an embodiment of the disclosure, in the cleaning device for the external sensor, time from interrupting cleaning to restarting cleaning is determined based on a tank capacity and replenishment frequency of the cleaning fluid.

According to an embodiment of the disclosure, in the cleaning device for the external sensor, the sensor performance calculation part determines whether to restart a stopped decontamination operation based on at least one of a distance traveled by the moving body to a destination, elapsed time for the cleaning part to stop the decontamination operation, the travel distance of the moving body, and a residual amount of the cleaning fluid.

According to an embodiment of the disclosure, the cleaning device for the external sensor further stops a driving support function of the moving body based on the calculated performance detection value of the external sensor.

According to an embodiment of the disclosure, in the cleaning device for the external sensor, the moving body is a vehicle, and the detection surface is a bumper or a windshield disposed in front of a detection direction of the external sensor.

According to an embodiment of the disclosure, in the cleaning device for the external sensor, the external sensor is a lidar.

According to an embodiment of the disclosure, the cleaning method for the external sensor further includes: determining the time from interrupting cleaning to restarting cleaning based on a tank capacity and replenishment frequency of the cleaning fluid.

According to an embodiment of the disclosure, the cleaning method for the external sensor also include: determining whether to restart a stopped decontamination operation based on at least one of a distance traveled by the moving body to a destination, elapsed time for a cleaning part to stop a decontamination operation, the travel distance of the moving body, and a residual amount of the cleaning fluid.

According to an embodiment of the disclosure, the cleaning method for the external sensor further includes: stopping a driving support function of the moving body based on the calculated performance detection value of the external sensor.

Reference will now be made in detail to the exemplary embodiments of the disclosure, examples of the exemplary embodiments are illustrated in the accompanying drawings. Whenever possible, the same reference numerals are used in the drawings and description to refer to the same or similar parts.

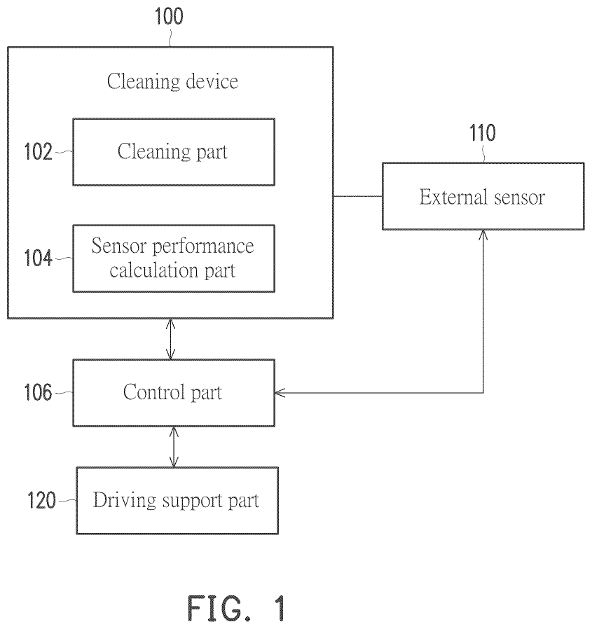

FIG. 1 is a schematic block diagram of a cleaning device for an external sensor according to an embodiment of the disclosure. As shown in FIG. 1, the cleaning device 100 for the external sensor may include but is not limited to: at least a cleaning part 102 and a sensor performance calculation part 104. The cleaning device 100 is configured to decontaminate an external sensor 110 of the vehicle when the external sensor 110 becomes dirty when the vehicle is driven with sand or the like being kicked up.

The cleaning part 102 of the cleaning device 100 may include, for example, a tank (not shown) for containing cleaning fluid, a spray head for spraying cleaning fluid on a detection surface of the external sensor 110, etc. In some types of external sensors 110, the cleaning part 102 may also include a scraping part for scraping off dirt on the detection surface sprayed with the cleaning fluid. As an example, the detection surface is a bumper or a windshield disposed in front of a detection direction of the external sensor 110.

As an example, the external sensor 110 may be a lidar, a radar, a camera, or any other sensor that can be installed outside the moving body. In addition, the moving body may include various drivable vehicles such as vehicles, two-wheelers, boats, or other similar appliances. In the following embodiments, the external sensor 110 will be a lidar as an example, and the moving body will be a vehicle as an example.

The sensor performance calculation part 104 is configured to calculate a performance detection value of the external sensor 110. The performance detection value is also called the degree of performance degradation, which will be further explained later. According to the disclosure, the cleaning part 102 can spray the cleaning fluid on the external sensor 110 based on the calculated performance detection value. Furthermore, the cleaning part 102 may spray the cleaning fluid on the external sensor 110 based on a calculated change amount of the performance detection value with respect to time or a travel distance of the vehicle.

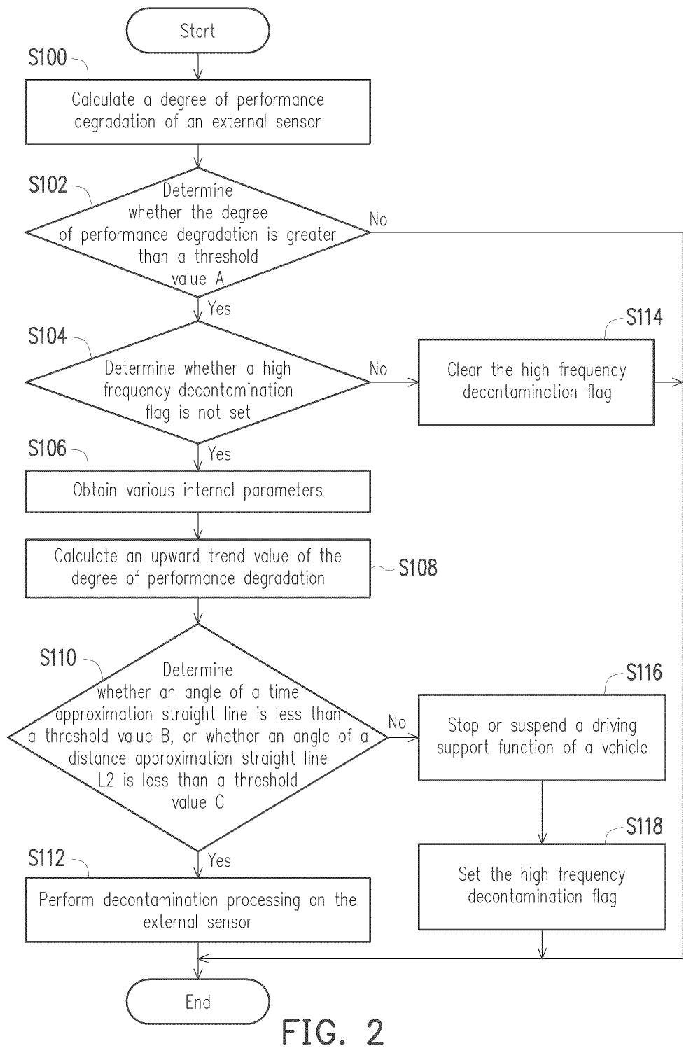

In addition, the cleaning device 100 may further include a control part 106 to independently control the cleaning device 100. The control part 106 may also be a part of the entire vehicle control device and implemented by a processor, such as an electronic control unit (ECU) of the vehicle. The ECU unit can be configured to control various sensors and detectors of the vehicle, such as the above-mentioned external sensor 110. Therefore, the control part 106 can receive data, perform various processing and judgment on the data, and then control various actuating components of the vehicle. Various system controls in the car are controlled by the ECU unit. The control part 106 can be configured to control each of the above-mentioned units. In addition, when used as an ECU unit, the control part 106 can also be configured to control the vehicle, such as controlling a driving support part 120 to control a driving support function. As a result, the control part 106 can control various behavior modes of the vehicle, such as acceleration and deceleration, parking, avoidance, etc., and also detect vehicle status or vehicle surrounding status by controlling various sensors and detectors. For those skilled in the art, various control methods of the control part 106 can be designed according to actual requirements. FIG. 2 is a schematic flowchart of a cleaning method for an external sensor according to

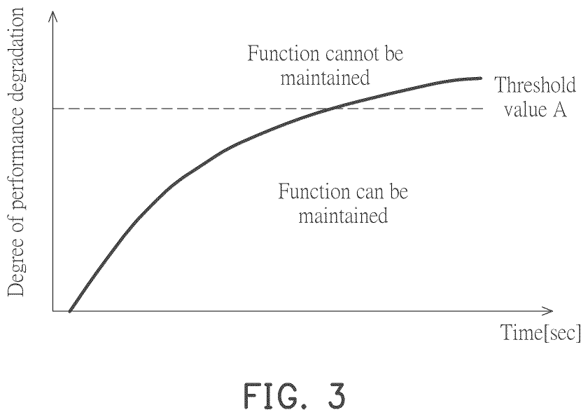

an embodiment of the disclosure. What is described in FIG. 2 is a control flow corresponding to the cleaning device shown in FIG. 1. As shown in FIG. 2, in step S100, the degree of performance degradation (performance detection value) of the external sensor is calculated. FIG. 3 is a diagram of an example of a performance detection value according to an embodiment of the disclosure. As shown in FIG. 3, the vertical coordinate represents the degree of performance degradation, while the horizontal coordinate represents time (seconds, sec). Generally speaking, the performance detection value of the external sensor, that is, the degree of performance degradation, will increase with time; that is to say, the longer the operation time of the external sensor, the detection performance will become lower, and the degree of performance degradation will become bigger.

Taking the lidar as an example, a detection surface of the lidar can be divided into multiple grating areas. If there are stains (sand, sludge, rain stains, dirty stains, etc.) in one grating area, it will be calculated as points (number). The cleaning device can set preset points and obtain the points. The points obtained are the points (number) that are actually determined to have stains in the grating area. Then, the above degree of performance degradation can be calculated by the following calculation formula:

Degree of performance degradation=points obtained/preset points

The above calculation of the degree of performance degradation is only an example. Those skilled in the art can use any appropriate method to calculate the degree of performance degradation according to the concept of the disclosure, and the disclosure is not specifically limited thereto.

Next, in step S102, it is determined whether the degree of performance degradation is greater than a threshold value A. When the degree of performance degradation is less than the threshold value A, it indicates that the external sensor is in a state where “the function can be maintained”. At this time, since the function of the external sensor can be maintained, the cleaning device 100 does not need to be activated to clean the external sensor. When the degree of performance degradation is greater than the threshold value A, it indicates that the external sensor is in a state where “the function cannot be maintained”. At this time, since the function of the external sensor cannot be maintained, the cleaning device 100 needs to be activated to clean the external sensor.

Therefore, when step S102 determines that the degree of performance degradation is less

than the threshold value A (i.e., “No”), the function of the external sensor can still operate, and the process ends. When step S102 determines that the degree of performance degradation is greater than the threshold value A (i.e., “Yes”), the function of the external sensor cannot be maintained at this time, and step S104 is performed.

In step S104, it is determined whether the high frequency decontamination flag is not set. If the determination result is not no (step S104, yes), then step S106 is performed.

In step S106, the cleaning device 100 obtains each internal parameter. This internal parameter is, for example, the value of the degree of performance degradation obtained immediately after the previous decontamination, the travel distance of the vehicle since the previous decontamination until now, the time since the previous decontamination until now, etc. The parameters listed here are only examples and can be modified to various other suitable parameters during implementation.

Next, in step S108, the cleaning device 100 calculates an upward trend value of the degree of performance degradation. The calculation method of the upward trend value of the degree of performance degradation will be explained below.

In step S110, the cleaning device 100 determines whether an angle of a time approximation straight line is less than a threshold value B, or whether an angle of a distance approximation straight line is less than a threshold value C. When the determination result of one of the above two conditions is yes, step S112 is performed. In addition, the determination condition of whether the angle of the time approximation straight line is less than the threshold value B and the determination condition of whether the angle of the distance approximation straight line is less than the threshold value C can also be carried out in an “AND” manner. That is, determination is made in a way in which the two determination conditions are established at the same time.

Next, specific examples of steps S106 to S110 will be further described. The following

illustrations are just a few examples, and in fact, different modifications and changes can be made according to requirements.

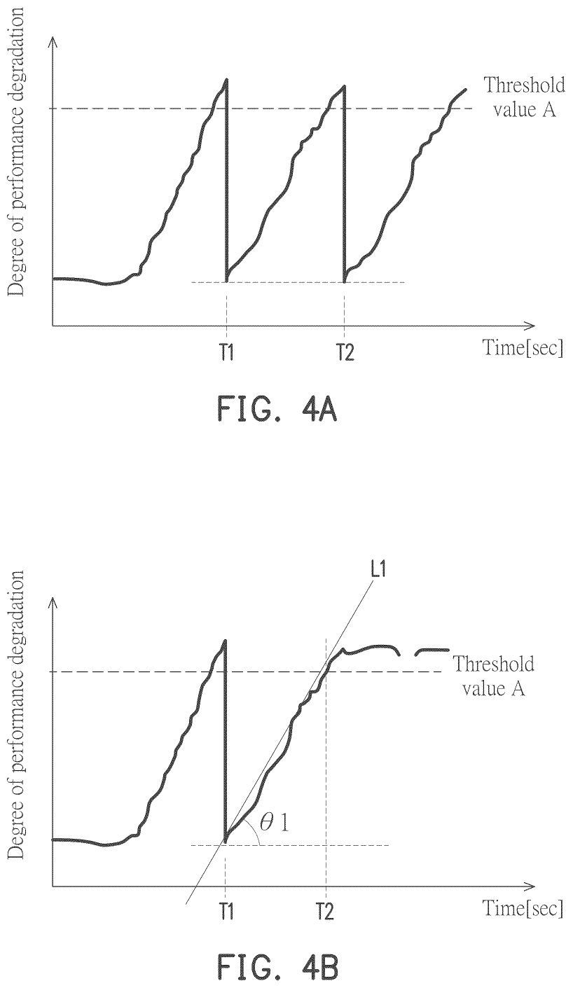

FIG. 4A is a schematic diagram of a short dirty cycle and repeated spraying of cleaning fluid. As shown in FIG. 4A, similar to FIG. 3, the vertical coordinate represents the degree of performance degradation, and the horizontal coordinate represents time (seconds, sec). Before time T1, after the degree of performance degradation of the external sensor 110 rises above the threshold value A, the cleaning fluid is sprayed on the external sensor 110 at the time T1.Subsequently, by spraying the cleaning fluid to remove dirt, the performance degradation of the external sensor 110 at the time T1 is also improved. However, if the cleaning fluid is sprayed on the external sensor 110 again in a short time, such as at time T2, at this time, since the frequency of the dirt removal operation is too frequent and the decontamination is repeated in a short cycle, the consumption of the cleaning fluid becomes unexpectedly fast. The usage status of the cleaning device 100 can be obtained through various internal parameters obtained in step S106.

Next, as shown in FIG. 4B, a method for calculating an upward trend value of the degree of performance degradation is illustrated. For example, a time approximation straight line L1 is calculated using the “degree of performance degradation-time” data shown in FIG. 4B through principal component analysis, etc., and then an angle (slope) θ1 is calculated from the time approximation straight line L1 to determine whether the angle θ1 is less than the threshold value B. In this example, the determination method is to use an approximate straight line with time as the horizontal axis.

Here, the time approximation straight line L1 is a straight line derived from the value of the degree of performance degradation between the times T1 and T2 shown in FIG. 4B. For example, in FIG. 4B, the time T1 represents the time after the external sensor 110 is decontaminated by spraying the cleaning fluid, and the time T2 represents the time when the value of the degree of performance degradation exceeds the threshold value A. After that, the corresponding value of the degree of performance degradation (i.e., performance detection value) is obtained from these two time points T1 and T2, and the time approximation straight line L1 and the angle θ1 thereof are calculated.

The time approximation straight line L1 represents a change rate of the degree of performance degradation over time from the time the external sensor 110 is decontaminated (time T1) to the next preparation for decontamination (time T2), which is also the frequency of the decontamination process. Therefore, when the angle θ1 of the time approximation straight line L1 is smaller, it means that the time from the previous decontamination process (time T1) to the next preparation for decontamination (time T2) is longer, and vice versa, it means that the time is shorter.

Therefore, if the angle θ1 of the time approximation straight line L1 exceeds the threshold value B, it means that the degree of performance degradation has increased in a short time since the external sensor was decontaminated last time, and the cleaning device 100 will not perform the decontamination process at this time. Therefore, it is possible to avoid the cleaning device 100 from frequently decontaminating the external sensor 110 and further consuming the cleaning fluid frequently.

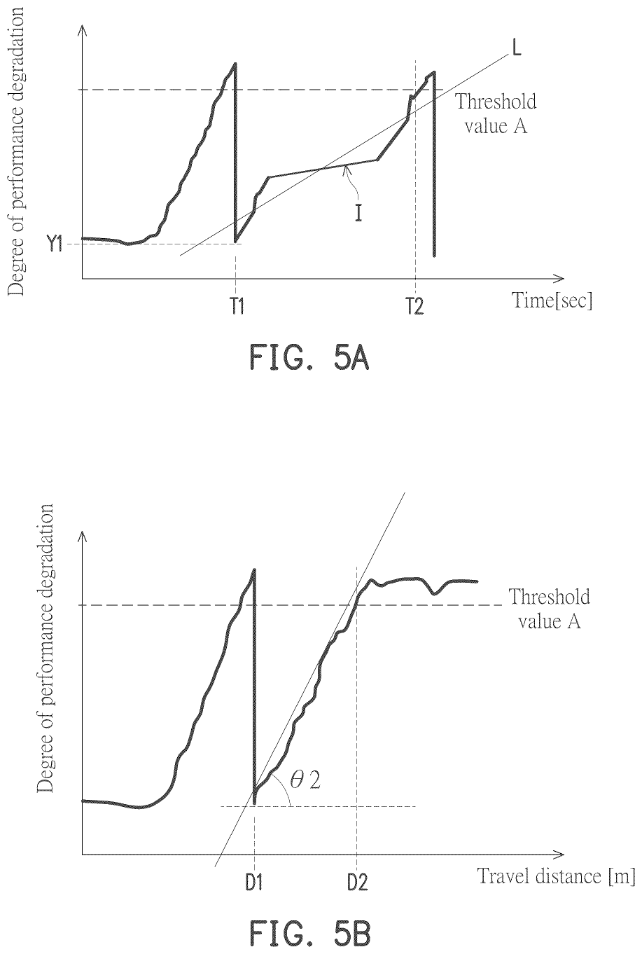

FIG. 5A is a schematic diagram of another example of a short dirty cycle and repeated spraying of cleaning fluid. As shown in FIG. 5A, similar to FIG. 3, the vertical coordinate represents the degree of performance degradation, and the horizontal coordinate represents time (seconds, sec). Before the time T1, after the degree of performance degradation of the external sensor 110 rises above the threshold value A, the cleaning fluid is sprayed on the external sensor 110 at the time T1. Subsequently, by spraying the cleaning fluid to remove dirt, the performance degradation of the external sensor 110 at the time T1 is also improved. In this example, the cleaning fluid is repeatedly sprayed over a short distance while the vehicle is at low speed or stopped.

As shown in FIG. 5A, if the vehicle is at low speed or stopped between time T1 and T2 (part of line segment I), and if the above time approximation straight line L1 is used to determine whether to allow the cleaning device 100 to perform decontamination processing, since the vehicle travels a short distance and the time difference (T2-T1) becomes longer, this situation will cause the angle θ1 of the time approximation straight line L1 to be lower than the threshold value B. At this time, the cleaning device 100 will start to perform decontamination processing. In this case, if the vehicle travels a short distance but the time interval is long enough, the cleaning fluid will be sprayed on the external sensor 110 again. At this time, since the frequency of the decontamination operation is too frequent and the decontamination is repeated over a short distance, the consumption of cleaning fluid becomes unexpectedly fast.

Therefore, the distance traveled by the vehicle needs to be taken into consideration. As shown in FIG. 5B, another method of calculating an upward trend value of a degree of performance degradation is illustrated. For example, a distance approximation straight line L2 is calculated using the “degree of performance degradation-distance” data shown in FIG. 5B through principal component analysis, etc., and then an angle (slope) θ2 is calculated from the distance approximation straight line L2 to determine whether the angle θ2 is less than the threshold value C. In this example, the determination method is to use an approximate straight line with distance as the horizontal axis.

Here, the distance approximation straight line L2 is a straight line derived from the value of the degree of performance degradation between distances D1 and D2 shown in FIG. 5B. For example, in FIG. 5B, the distance D1 represents a travel distance after spraying the cleaning fluid to decontaminate the external sensor 110, and the distance D2 represents a travel distance in which the value of the degree of performance degradation exceeds the threshold value A. After that, the corresponding value of the degree of performance degradation (that is, the performance detection value) is obtained from the two distances D1 and D2, and the distance approximation straight line

L2 and the angle θ2 thereof are calculated.

The distance approximation straight line L2 represents a change rate of the degree of performance degradation over time from the time after the external sensor 110 is decontaminated (distance D1) to the next preparation for decontamination (distance D2), which is also the frequency of the decontamination process. Therefore, when the angle θ2 of the distance approximation straight line L2 is smaller, it means that the travel distance from the previous decontamination process (distance D1) to the next preparation for decontamination (distance D2) is longer, and vice versa, it means that the travel distance is shorter.

Therefore, if the angle θ2 of the distance approximation straight line L2 exceeds the threshold value C, it means that the degree of performance degradation has increased within a short distance since the external sensor was previously decontaminated, and the cleaning device 100 will not perform the decontamination process at this time. Therefore, it is possible to avoid the cleaning device 100 from frequently decontaminating the external sensor 110 and further consuming the cleaning fluid frequently.

According to the embodiment of the disclosure, the threshold value B and the threshold value C are determined. First, internal parameters are obtained from the vehicle, and then the threshold value B and the threshold value C are calculated therefrom. The internal parameters include, for example, the tank capacity of the cleaning fluid, information on the number of days expected to replenish the cleaning fluid tank, information on travel distance/travel time, information on travel location, and the like.

Regarding the tank capacity of the cleaning fluid, it can be extracted from the vehicle information. The memory in the control system of the vehicle may store various vehicle-related information, one of which may be the tank capacity of the cleaning fluid tank of the cleaning device 100 of various external sensors 110. Information on the number of days expected to replenish the cleaning fluid tank can also be extracted from the vehicle information, and can also be obtained from the user login information.

As an example, cleaning fluid replenishment can be provided with options of 1 month, 2 months, or 3 or more months, etc., and is performed by writing to the memory. In addition, a user interface can also be provided to allow users to make choices. As another example, usage conditions can also be selected to set the cleaning fluid replenishment. For example, the vehicle control system can provide modes such as energy saving priority, automatic drive (AD) function priority, automatic, etc. for the user to choose. The energy saving priority can be set to a cleaning fluid replenishment time of more than 3 months, the AD function priority can be set to a cleaning fluid replenishment time of more than 1 month, and the automatic mode, for example, switches to an energy saving trend when the remaining amount of the cleaning tank is lower than a specified level.

In addition, the vehicle control system can calculate information about the user's average travel distance per day, travel time information, and travel location information from past travel data. In addition, the user's average daily travel distance and travel time information may be determined in advance, or may be rewritten via the network from statistics of users within a certain range (nationwide, etc.).

The information about the travel position can be determined from, for example, the position information of past travel and the current position information. In addition, in situations where the route is different from the normal travel route, it can be changed to the AD function priority (for example, in exchange for one month). Also, the travel position information is not necessarily required.

Then, from the various information, the average travel time per day (or average travel distance per day), tank capacity, number of replenishment days, etc. can be determined.

Next, the threshold value B of the time approximation straight line L1 can be calculated in the following way:

The allowable spraying time interval for each trip =average travel time per day/(tank capacity/number of replenishment days);

Threshold value B=arctan (threshold value A/allowable spraying time interval for each trip).

Next, the threshold value C of the distance approximation straight line L2 can be

calculated in the following way:

The allowable spraying distance interval for each trip=average travel distance per day/(tank capacity/number of replenishment days);

Threshold value C=arctan (threshold value A/allowable spraying distance interval for each trip).

As described above, when in step S110, the cleaning device 100 determines that the angle 01 of the time approximation straight line L1 is less than the threshold value B, or determines that the angle 02 of the distance approximation straight line L2 is less than the threshold value C (i.e., Yes), step S112 is performed. In step S112, the cleaning device 100 performs decontamination processing on the external sensor 110. That is, the cleaning device 100 sprays the cleaning fluid onto the external sensor 110 to remove dirt and ends the control process.

Furthermore, in step S110, when the cleaning device 100 determines that the angle 01 of the time approximation straight line L1 is greater than the threshold value B, or determines that the angle θ2 of the distance approximation straight line L2 is greater than the threshold value C, step S116 is performed. In step S116, the vehicle control device (for example, implemented by the control part 106) may stop or suspend the driving support function (driving support part 120) of the vehicle based on the above determination result of the cleaning device 100. Afterwards, in step S118, the cleaning device 100 sets the high frequency decontamination flag, and then ends the process.

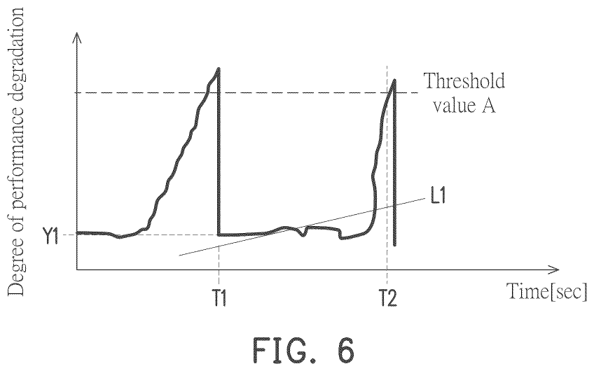

FIG. 6 is another method of calculating an increasing trend value of a degree of performance degradation. As shown in FIG. 6, it illustrates a situation in which the degree of performance degradation of the external sensor 110 increases rapidly. For example, the detection surface of the external sensor 110 is suddenly blocked, causing the degree of performance degradation to increase rapidly. In this situation, the slope (angle) of the time approximation straight line L1 becomes smaller and may be lower than the threshold value B. At this time, although there is no problem, the cleaning device 100 still sprays the cleaning fluid on the external sensor 110 to perform decontamination processing.

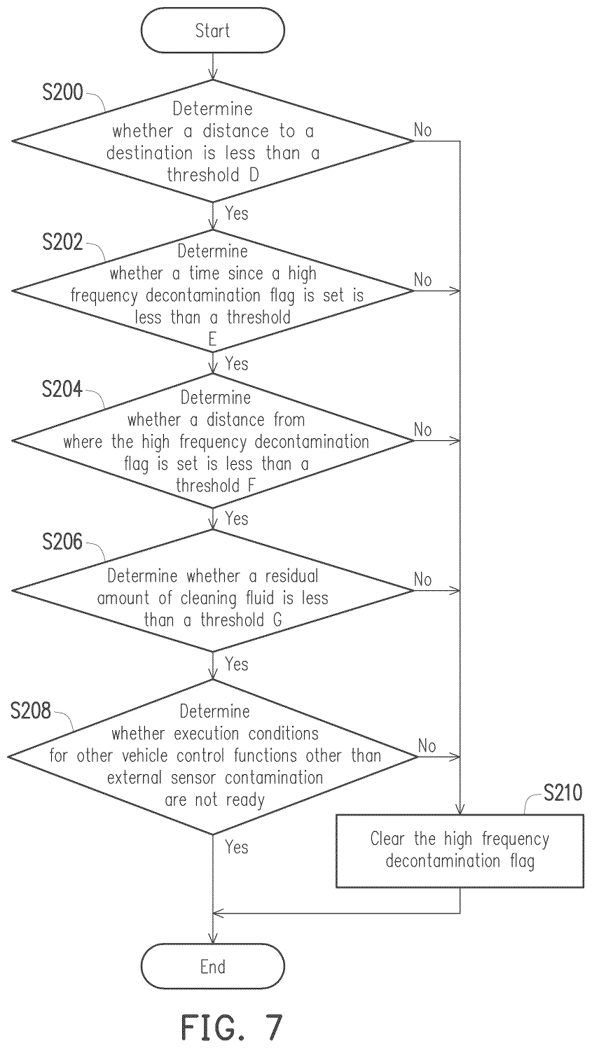

In addition, when step S104 determines that the high frequency decontamination flag is set (step S104, No), step S112 is performed to clear the high frequency decontamination flag. FIG. 7 is a schematic flowchart of a process of clearing a high frequency decontamination flag in an external sensor cleaning process according to an embodiment of the disclosure.

As shown in FIG. 7, in step S200, the cleaning device 100 determines whether the distance of the vehicle to the destination is less than a threshold value D. If the distance to the destination is less than the threshold value D (“Yes”), proceed to subsequent step S202. On the other hand, if the distance to the destination is greater than the threshold value D (“No”), step S210 is performed to prepare for the next drive to remove dirt, clear the high frequency decontamination flag, and end the control process. At this time, cleaning to remove dirt can also be performed.

In step S202, the cleaning device 100 determines whether the time since the high frequency decontamination flag is set is less than a threshold value E. If the set time is less than the threshold value E (“Yes”), proceed to subsequent step S204. On the contrary, if the set time is greater than the threshold value E (“No”), step S210 is performed to clear the high frequency decontamination flag and end the control process.

In step S204, the cleaning device 100 determines whether the distance from where the high frequency decontamination flag is set is less than a threshold value F. If the set distance is less than the threshold value F (“Yes”), proceed to subsequent step S206. On the contrary, if the set distance is greater than the threshold value F (“No”), step S210 is performed to clear the high frequency decontamination flag and end the control process.

In step S206, the cleaning device 100 determines whether the residual amount of cleaning fluid is less than a threshold value G. If the residual amount of the cleaning fluid is less than the threshold value G (“Yes”), it indicates that the residual amount of the cleaning fluid is insufficient, and the control process ends. On the contrary, if the residual amount of the cleaning fluid is greater than the threshold value G (“No”), it means that the residual amount of the cleaning fluid is sufficient, and step S210 is performed to clear the high frequency decontamination flag and end the control process.

Furthermore, other vehicle control functions may also be integrated according to embodiments of the disclosure. For example, in step S208, the vehicle's control system (as an example, the above-mentioned control part 106) determines whether execution conditions for other vehicle control functions other than external sensor contamination are not ready. When the execution conditions for other vehicle control functions are not ready, the control process ends. At this time, since other vehicle control functions are not ready for execution and may not be able to drive, decontamination processing does not need to be performed on the external sensors. On the contrary, if the execution conditions for other vehicle control functions are ready, step S210 is performed to clear the high frequency decontamination flag and end the control process. That is, the cleaning device 100 may perform decontamination processing if the conditions for performing vehicle control functions other than sensor contamination are met.

If any of the determination results in the above-mentioned steps S200 to S208 is negative, step S210 is performed. That is, the high frequency decontamination flag is cleared, and the control process ends. In addition, cleaning to remove dirt can be performed at the same time as clearing the high frequency decontamination flag. In addition, the conditions described in the above-mentioned steps S200 to S208 can also be determined in an “AND” manner, that is, determined in a way in which the conditions are established at the same time.

In addition, the above-mentioned thresholds E, F, and G may be fixed values, or may be set based on the user's travel information settings. For example, the average travel time or average travel distance for each trip, or a specified ratio of these values (such as 1/2, etc.). In addition, the above-mentioned thresholds E, F, and G can also be set directly by the user.

In addition, only part of the conditions described in the above steps S200 to S208 may be used. In addition, the order of determining the conditions in the above-mentioned steps S200 to S208 is not particularly limited and can be adjusted arbitrarily.

According to the above-described embodiment, in the case where the sensor continues to become dirty, unintentional consumption of the cleaning fluid is avoided by suppressing the execution of dirt removal. Thus, the replenishment frequency of the cleaning fluid can be optimized.

Finally, it should be noted that the above embodiments are merely used to illustrate the technical solution of the disclosure, but not to limit the disclosure. Although the disclosure has been described in detail with reference to the embodiments, it should be understood that persons of ordinary skill in the art can still modify the technical solutions recorded in the embodiments or make equivalent substitutions for some or all of the technical features. However, the modifications or substitutions do not cause the essence of the corresponding technical solution to depart from the scope of the technical solution of the embodiments of the disclosure.

What is claimed is:

1. A cleaning device for an external sensor, wherein the external sensor is disposed on a moving body, and configured to detect an outside of the moving body, the cleaning device for the external sensor comprising:
a cleaning part, configured to spray cleaning fluid on a detection surface of the external sensor for cleaning; and
a sensor performance calculation part, configured to calculate a performance detection value of the external sensor,
wherein the cleaning part sprays the cleaning fluid based on the calculated performance detection value,
wherein the cleaning part sprays the cleaning fluid based on a calculated change amount of the performance detection value with respect to time or a travel distance of the moving body.

2. The cleaning device for the external sensor according to claim 1, wherein
time from interrupting cleaning to restarting cleaning is determined based on a tank capacity and replenishment frequency of the cleaning fluid.

3. The cleaning device for the external sensor according to claim 1, wherein
the sensor performance calculation part determines whether to restart a stopped decontamination operation based on at least one of a distance traveled by the moving body to a destination, elapsed time for the cleaning part to stop the decontamination operation, the travel distance of the moving body, and a residual amount of the cleaning fluid.

4. The cleaning device for the external sensor according to claim 1, wherein
a driving support function of the moving body is stopped based on the calculated performance detection value of the external sensor.

5. The cleaning device for the external sensor according to claim 1, wherein
the moving body is a vehicle, and the detection surface is a bumper or a windshield disposed in front of a detection direction of the external sensor.

6. The cleaning device for the external sensor according to claim 1, wherein:
the external sensor is a lidar.

7. A cleaning method for an external sensor, wherein the external sensor is disposed on a moving body, and configured to detect an outside of the moving body, the cleaning method for the external sensor comprising:
spraying cleaning fluid on a detection surface of the external sensor for cleaning;
calculating a performance detection value of the external sensor;
spraying the cleaning fluid based on the calculated performance detection value; and
spraying the cleaning fluid based on a calculated change amount of the performance detection value with respect to time or a travel distance of the moving body.

8. The cleaning method for the external sensor according to claim 7, further comprising:
determining time from interrupting cleaning to restarting cleaning based on a tank capacity and replenishment frequency of the cleaning fluid.

9. The cleaning method for the external sensor according to claim 7, further comprising:
determining whether to restart a stopped decontamination operation based on at least one of a distance traveled by the moving body to a destination, elapsed time of stopping the decontamination operation, the travel distance of the moving body, and a residual amount of the cleaning fluid.

10. The cleaning method for the external sensor according to claim 7, further comprising:
stopping a driving support function of the moving body based on the calculated performance detection value of the external sensor.
